(19) United States
(12) Patent Application Publication
(10) Pub. No.: US 2022/0383332 A1
(43) Pub. Date: Dec. 1, 2022

(54) SYSTEMS AND METHODS FOR MANAGING AND ANALYZING CUSTOMER INTERACTIONS

(71) Applicant: ConvergeOne, Inc., Parsippany, NJ (US)

(72) Inventors: Bruce Calhoon, Pittsboro, NC (US); Mark Langanki, Minneapolis, MN (US); Sivaraj Palanisamy, Cary, NC (US)

(21) Appl. No.: 17/676,519

(22) Filed: Feb. 21, 2022

Related U.S. Application Data
(60) Provisional application No. 63/192,838, filed on May 25, 2021.

(51) Int. Cl. G06Q 30/00

(52) U.S. Cl. CPC G06Q 30/016

(57) ABSTRACT

Aspects of the present disclosure relate to managing and analyzing customer interactions. In examples, a system for managing customer interactions, comprises at least one processor and memory storing instructions that, when executed by the at least one processor, causes the system to perform a set of operations. The set of operations comprises receiving an initiation of an interaction from a user via a channel, the interaction comprising interaction data. The set of operations further comprise identifying the user based on the interaction data and determining context data associated with the user; Further, the set of operations comprises determining an intent of the interaction based upon the interaction data and the context data.

### RELATED APPLICATION

The present application claims priority to U.S. Provisional Application 63/192,838, filed on May 25, 2021, the disclosure of which is incorporated herein by reference in its entirety.

### TECHNICAL FIELD

The present disclosure relates generally to customer interactions and, more particularly, the present disclosure relates to managing and analyzing customer interactions.

### BACKGROUND

Businesses interact with customers via a variety of different sources. These interactions can include, for example, customer inquiries and requests related to a product or service. For example, businesses can receive inquiries and requests via the business's online help desk, call center, text, social media accounts, etc. Oftentimes, businesses have difficulty managing the conversations about the same inquiry or request that is received at two different times and/or via two different sources, such as a conversation about an inquiry or a request received via the business's help desk and a conversation pertaining to the same inquiry or request via the business's social media account. Moreover, these multiple sources make it exceedingly difficult for businesses to gain actionable insights to ensure the effectiveness of their customer interactions.

It is with respect to these and other general considerations that embodiments have been described herein. Although relatively specific problems have been discussed, it should be understood that the embodiments should not be limited to solving the specific problems identified in the background.

### SUMMARY

Aspects of the present disclosure relate to managing and analyzing customer interactions. Example embodiments include, but are not limited to the following examples.

In an Example 1, a system for managing customer interactions, the system comprises: at least one processor; and memory storing instructions that, when executed by the at least one processor, causes the system to perform a set of operations, the set of operations comprising receiving an initiation of an interaction from a user via a first channel, the interaction comprising interaction data; identifying the user based on the interaction data; determining context data associated with the user; determining an intent of the interaction based upon the interaction data and the context data; encapsulating the interaction, the intent of the interaction, the interaction data, and the context data into an interaction capsule; and routing the interaction capsule to an agent for completion of an action in response to the intent of the interaction.

In an Example 2, the system of Example 1, wherein determining context data associated with the user comprises: associating the user with at least one previous interaction of the user, determining one or more previous interactions of the at least one previous interaction that are relevant to the interaction; and including previous interaction data associated with the one or more previous interactions in the context data.

In an Example 3, the system of Example 2, wherein the at least one previous interaction is associated with a second channel that is different than the first channel.

In an Example 4, the system of Example 3, wherein the first channel and the second channel are selected from the following group of channels: voice, email, webchat, SMS, Facebook Messenger, Twitter, Skype, MS teams, Cisco Teams, Slack, LINE, WhatsApp, or YouTube.

In an Example 5, the system of Example 2, wherein determining one or more previous interactions of the at least one previous interaction that are relevant to the interaction comprises: determining a state of the one or more previous interactions, wherein the state comprises an open state or a closed state; and determining only a previous interaction of the one or more previous interactions having an open state are relevant to the interaction.

In an Example 6, the system of Example 5, wherein determining the intent of the interaction comprises using an intent of the previous interaction as the intent of the interaction.

In an Example 7, the system of Example 1, wherein determining the intent of the interaction comprises: accessing a database of a plurality of intents, each of the plurality of intents being associated with context data; matching the interaction data and the context data to the context data associated with one or more intents of the plurality of intents; and determining the intent of the interaction as the intent of the plurality of intents being associated with the intent data.

In an Example 8, the system of Example 1, wherein the set of operations further comprises determining an action in response to the intent of the interaction, wherein the action is included in the interaction capsule.

In an Example 9, the system of Example 8, wherein the set of operations further comprises: determining the agent to fulfill the action, wherein the agent is a virtual agent or a human agent; and routing the interaction and an interaction capsule to the agent, the interaction capsule comprising the intent of the interaction and the action.

In an Example 10, the system of Example 1, wherein the set of operations further comprises: determining the interaction is associated with the at least one previous interaction; and updating an interaction capsule based on the interaction.

In an Example 11, a method for managing customer interactions, the method comprising receiving an initiation of an interaction from a user via a first channel, the interaction comprising interaction data; identifying the user based on the interaction data; determining context data associated with the user; and determining an intent of the interaction based upon the interaction data and the context data.

In an Example 12, the method of Example 11, wherein determining context data associated with the user comprises: associating the user with at least one previous interaction of the user; determining one or more previous interactions of the at least one previous interaction that are relevant to the interaction; and including previous interaction data associated with the one or more previous interactions in the context data.

In an Example 13, the method of Example 12, wherein the at least one previous interaction is associated with a second channel that is different than the first channel.

In an Example 14, the method of Example 13, wherein the first channel and the second channel are selected from the following group of channels: voice, email, webchat, SMS, Facebook Messenger, Twitter, Skype, MS teams, Cisco Teams, Slack, LINE, WhatsApp, or YouTube.

In an Example 15, the method of Example 12, wherein determining one or more previous interactions of the at least one previous interaction that are relevant to the interaction comprises: determining a state of the one or more previous interactions, wherein the state comprises an open state or a closed state; and determining only a previous interaction of the one or more previous interactions having an open state are relevant to the interaction.

In an Example 16, the method of Example 15, wherein determining the intent of the interaction comprises using an intent of the previous interaction as the intent of the interaction.

In an Example 17, the method of Example 11, wherein determining the intent of the interaction comprises: accessing a database of a plurality of intents, each of the plurality of intents being associated with context data; matching the interaction data and the context data to the context data associated with one or more intents of the plurality of intents; and determining the intent of the interaction as the intent of the plurality of intents being associated with the intent data.

In an Example 18, the method of Example 11, further comprising determining an action in response to the intent of the interaction.

In an Example 19, the method of Example 18, further comprising: determining an agent to fulfill the action, wherein the agent is a virtual agent or a human agent; and routing the interaction and an interaction capsule to the agent, the interaction capsule comprising the intent of the interaction and the action.

In an Example 20, the method of Example 11, further comprising: determining the interaction is associated with the at least one previous interaction; and updating an interaction capsule based on the interaction.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a diagram of an example system for managing and analyzing customer interactions.

FIG. 2 is a flow diagram of an example method for managing a customer interaction.

FIG. 3 is a diagram of an example customer interaction engine.

FIGS. 4A and 4B are diagrams of an example association between an intent and context data.

FIG. 5 is a diagram of an example of customer identification and intent tracking.

FIG. 6 is a diagram of an example of an interaction cycle fulfillment.

FIG. 7 is a diagram of an example of intent lifecycle.

FIG. 8 is a flow diagram of a method for managing and analyzing customer interactions.

FIG. 9 is a flow diagram of an example customer interaction.

FIG. 10 is an example of a fulfillment of the customer interaction depicted in FIG. 9.

FIG. 11 is a flow diagram of another example customer interaction.

FIG. 12 is a block diagram illustrating physical components (e.g., hardware) of a computing device with which aspects of the disclosure may be practiced.

FIG. 13A is a simplified diagram of a mobile computing device with which aspects of the present disclosure may be practiced.

FIG. 13B is another simplified block diagram of a mobile computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As set forth above, businesses have difficulty managing conversations about the same inquiry or request that is received at two or more different times and/or via two or more different sources. Moreover, the advent of asynchronous digital channels (SMS, InApp messaging—mobile and secure portals, social media messaging applications, etc.) and bots powered with artificial intelligence and machine learning (collectively, Intelligent Virtual Assistants or IVAs, or Virtual Agents) compound the challenge. For example, with smart phones and social media, a customer is always-on a communication-enabled device and portal, and asynchronous conversations may span hours or days. Asynchronous conversations may or may not be ended by the customer and human agent, as is most often the case with voice and chat conversations. Throughout these always-on communications, a broad range of real-time and historical operational, transactional, personal, sentiment, and financial data is made available. Moreover, in business communications, such as customer support, an IVA may be forced to repetitively interrogate the customer by, for example, asking the identity of the customer and why the customer is contacting the business, leading to an inefficient and often frustrating conversation for the customer. In addition, if the conversation moves to a human agent, activity undertaken previously by the IVA may not be available to the agent and the customer is interrogated again. This leads to disjointed customer journeys and experiences.

Embodiments disclosed herein alleviate these problems by describing a customer interaction engine. The customer interaction engine can be a central point for customer communication, such that the customer interaction engine records transactions and stores/manages relevant context based on outcomes. According to certain embodiments, the customer interaction engine assembles, synthesizes, encapsulates, and processes this data into interaction capsules, each of which is highly-specific to customers and outcomes. The interaction capsule can provide relevant and current customer context, such as who is the customer engaged in the interaction, why and how is the customer contacting the business, what is the relevant conversation history, and what is the next e st action to be taken based on the foregoing context. In certain instances, relevant data included in the interaction capsule can be used for current and/or future interactions. In some examples, relevant data can be pulled from the interaction capsule using machine learning.

In certain embodiments, the interaction capsule can be labelled as open or closed. In instances where the interaction capsule is open, the context data included in the interaction capsule can be provided to a virtual agent or a human agent to carry out the next best action for an interaction. As a result of these embodiments, the customer interaction engine allows various methods, such as data science methods, including machine learning techniques, to achieve actionable business insights previously unattainable for each customer interaction.

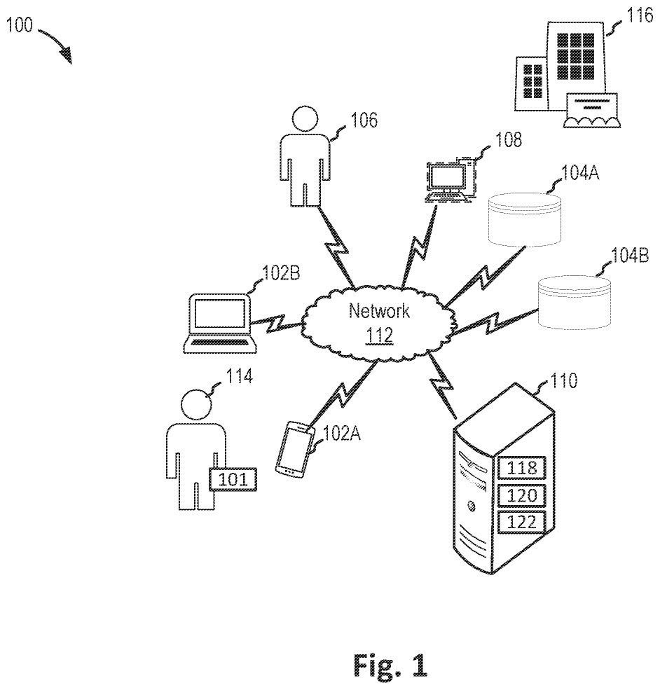

FIG. 1 illustrates an overview of an example system 100 for managing and analyzing customer interactions 101, in accordance with at least some embodiments of the present disclosure. This diagram is merely an example, which should not unduly limit the scope of the claims. One of ordinary skill in the art would recognize many variations, alternatives, and modifications are possible in light of the present disclosure.

According to certain embodiments, the system 100 includes one or more user electronic devices 102, a customer database 104A, a customer system of records database 104B (e.g., data from a customer resource management (CRM) system), a human agent 106, a virtual agent 108, and/or a customer interaction engine 110, which are coupled together via a network 112. The network 112 may be, or include, any number of different types of communication networks such as, for example, a bus network, a short messaging service (SMS), a local area network (LAN), a wireless LAN (WLAN), a wide area network (WAN), the Internet, a P2P network, custom-designed communication or messaging protocols, and/or the like. The network 112 may include a combination of multiple networks.

User electronic devices 102 may be any of a variety of computing devices, including but not limited to, a mobile computing device, a laptop computing device, a tablet computing device, or a desktop computing device. It will be appreciated that while system 100 is illustrated as comprising more than one user electronic device 102, a customer database 104A, a customer system of records database 104B, one human agent 106, one virtual agent 108, and one customer interaction engine 110, any number of such elements may be used in other examples. Further, the functionality described herein with respect to customer interaction engine 110 may be distributed among or otherwise implemented on any number of different computing devices in any of a variety of other configurations in other examples.

In aspects, a user 114 can contact a company 116 via a channel associated with the company 116 on a user device 102. Channel examples include, but are not limited to, voice, email, webchat, SMS, Facebook Messenger, Twitter, Skype, MS teams, Cisco Teams, Slack, LINE, WhatsApp, etc. In certain embodiments, the user 114 contacts the company 116 about a product or service associated with the company 116. In some aspects, the user 114 is a current or prospective customer of the company 116. The initiation of contact by a user 114 can be referred to herein as an interaction 101.

According to certain examples, a human agent 106 and/or a virtual agent 108 associated with a company 116 can receive the interaction 101 initiated by the user 114. The human agent 106 and/or a virtual agent 108 can provide a response to the interaction 101 and/or fulfill any requests associated with the interaction 101.

To facilitate providing a response to the interaction 101 and/or fulfilling any requests included in the interaction 101, the customer interaction engine 110 can provide information to the human agent 106 and/or the virtual agent 108. The information provided by the customer interaction engine 110 to the human agent 106 and/or the virtual agent 108 can be included in an interaction capsule 118. In certain embodiments, the customer interaction engine 110 analyzes context data about the user 114 and the interaction 101 to determine an identity of the user 114, an intent of the interaction 101, and/or any potential actions to be taken in response to the intent of the interaction 101. This information can be included in the interaction capsule 118 so that the human agent 106 and/or virtual agent 108 can provide a better, more efficient response to the interaction 101.

To create an interaction capsule 118, the customer interaction engine 110 can collect user data pertaining to the user 114. To collect user data, the customer interaction engine 110 identifies and matches the user 114 to previous interactions 120 of the user 114. The previous interactions 120 can be included in the interaction capsule 118. In some embodiments, the previous interactions 120 could have been initiated via a variety of channels associated with the company 116. As set forth above, examples of channels include, but are not limited to, voice, email, webchat, SMS, Facebook Messenger, Twitter, Skype, MS teams, Cisco Teams, Slack, LINE, WhatsApp, etc. Furthermore, the customer interaction engine 110 can match the user 114 to previous user information provided via other sources, such YouTube comments and/or other types of comments, e.g., user reviews on Amazon or other websites associated with the company 116. In addition, the customer interaction engine 110 can access information about customers stored in a customer database 104A and/or a customer system of records 104B associated with the company 116. Collectively, this information may be referred to herein as user data 122 and can be included in the interaction capsule 118.

After collecting the user data 122 and including the user data 122 in the interaction capsule 118, the customer interaction engine 110 can extract meaning and/or actions from the interaction capsule 118 using machine learning. For example, the customer interaction engine 110 can analyze the user data 122 included in the interaction capsule 118 and the interaction 101 to determine whether user data 122 and/or what user data 122 pertains to the interaction 101. For example, the customer interaction engine 110 can analyze the user data 122 to determine whether any of the previous interactions 120 included in the user data 122 pertain to the interaction 101. By ascertaining whether any previous interactions 120 pertain to the interaction 101, the customer interaction engine 110 can better determine the intent of the interaction 101, as explained in more detail below. Once the intent is determined, the customer interaction engine 110 can determine action items in response to the intent. As set forth above, the identity of the user, the intent of the interaction 101, and/or the action items for the interaction 101 can be included in the interaction capsule 118.

Once an intent and/or action items are determined, the customer interaction engine 110 can determine the agent (e.g., a human agent 106 or a virtual agent 108) and the channel (e.g., chat, email, voice, etc.) that is best suited to fulfill the action item for the interaction 101. In doing so, customer interaction engine 110 can route the interaction 101 and the interaction capsule 118 to the appropriate agent (e.g., a human agent 106 or a virtual agent 108) for fulfillment of the action pertaining to the interaction 101.

Because the customer interaction engine 110 collects the user data 122 included in the variety of channels and sources set forth above and relates the interaction 101 to any relevant user data 122 previously obtained, the customer interaction engine 110 can provide better and/or more accurate information, such as intent and action items, to an agent 106, 108 in the interaction capsule 118 in comparison to convention embodiments, thereby enabling the agent 106, 108 to provide a better and/or a more efficient response to the interaction 101 initiated by the user 114. Furthermore, by determining the agent 106, 108 best suited to fulfill any action items for the interaction 101, the customer interaction engine 110 enables better and/or a more efficient response to the interaction 101, in comparison to conventional embodiments.

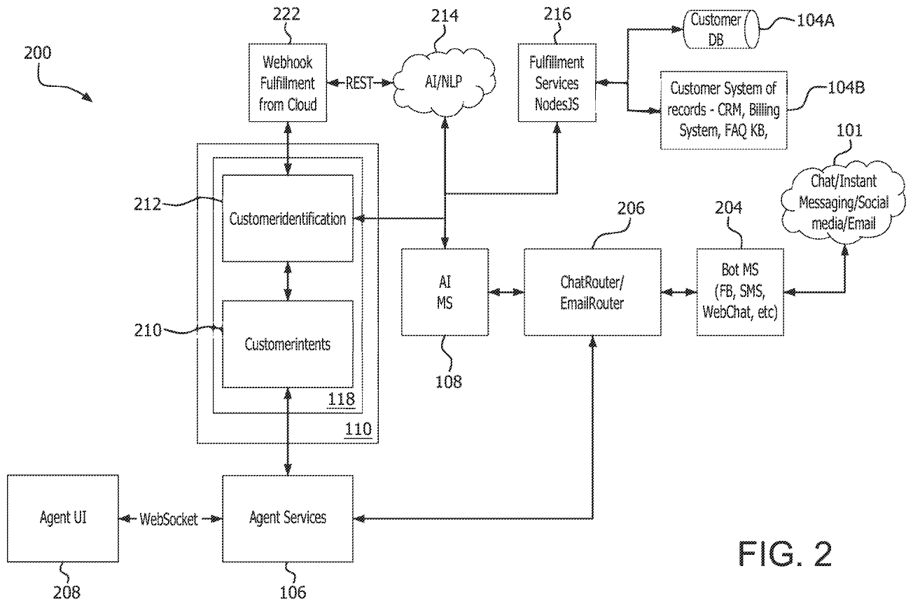

FIG. 2 illustrates a flow diagram of a method 200 for managing an interaction 101, in accordance with at least some embodiments of the present disclosure. This diagram is merely an example, which should not unduly limit the scope of the claims. One of ordinary skill in the art would recognize many variations, alternatives, and modifications are possible in light of the present disclosure.

As illustrated, the method 200 includes receiving an initiation of an interaction 101 via a channel 204 associated with a company 116. The channel 204 associated with the company 116 can include, but is not limited to, the company's help desk call number or other voice number, email address, webchat, SMS, Facebook Messenger, Twitter, Skype, MS teams, Cisco Teams, Slack, LINE, WhatsApp, etc. In instances, the interaction 101 is received by an interaction router 206, which routes the interaction 101 to an agent, for example, a virtual agent 108 or a human agent 106 via a human agent UI 208.

In certain examples, prior to routing the interaction 101 to a virtual agent 108 or a human agent 106, the customer interaction engine 110 can analyze the interaction 101 to determine whether the interaction 101 can be better answered by a virtual agent 108 or a human agent 106. To do so, the customer interaction engine 110 can determine the interaction intent 210 and any actions for responding to the interaction intent 210. In certain instances, the customer interaction engine 110 can determine the interaction intent 210 using the interaction 101 and the interaction capsule 118, as described in certain examples below. In instances where the actions are better or more efficiently performed by a virtual agent 108, the interaction 101 can be routed to the virtual agent 108. In instances where the actions are better or more efficiently performed by a human agent 106, the interaction 101 can be routed to the human agent 106.

In certain instances, a decision to route the interaction 101 to a virtual agent 108 or a human agent 106 can be based on one or more criteria including, for example, the following criteria:
1. The virtual agent 108 can be trained using machine learning to recognize the need for human agent. For example, if the virtual agent 108 goes through to a default intent a number of times, the virtual agent 108 will suggest to transfer to human agent.
2. The interaction 101 can be routed based on different actions associated with the intent of the interaction 101.
3. A rules engine can be used to route the interaction 101, such that the rules engine is defined by a contact center manager/supervisor based on several criteria included in the user data 122.
4. If there is an issue with reaching a virtual agent 108, the interaction 101 can be routed to a human agent 106 and vice versa.
5. The customer can ask for human agent 106 and, as a result, can be routed to a human agent 106.

However, these are only examples and not meant to be limiting.

Along with routing the interaction 101, the customer interaction engine 110 can route the interaction capsule 118 including the user identity 212 and the interaction intent 210 to the agent 106, 108 that receives the interaction 101. By knowing the user identity 212 and the interaction intent 210, the agent 106, 108 can provide better service to the user of the interaction 101. For example, repetitive interrogations of the user 114 in order to determine the interaction intent 210, the user identity 212, and/or any actions to respond to the interaction intent 210 can be avoided.

In instances, the virtual agent 208 can access a natural language processing and/or artificial intelligence module 214 to interpret the interaction 101, the interaction capsule 118, the user identity 212, and/or the interaction intent 210 in order to fulfill the interaction 101. In instances, the interaction 101 can be fulfilled by a fulfillment module 216. According to certain instances, the fulfillment module 216 can access the customer database 104A and/or another customer system of records 104B (e.g., Webhook) to fulfill the interaction 101.

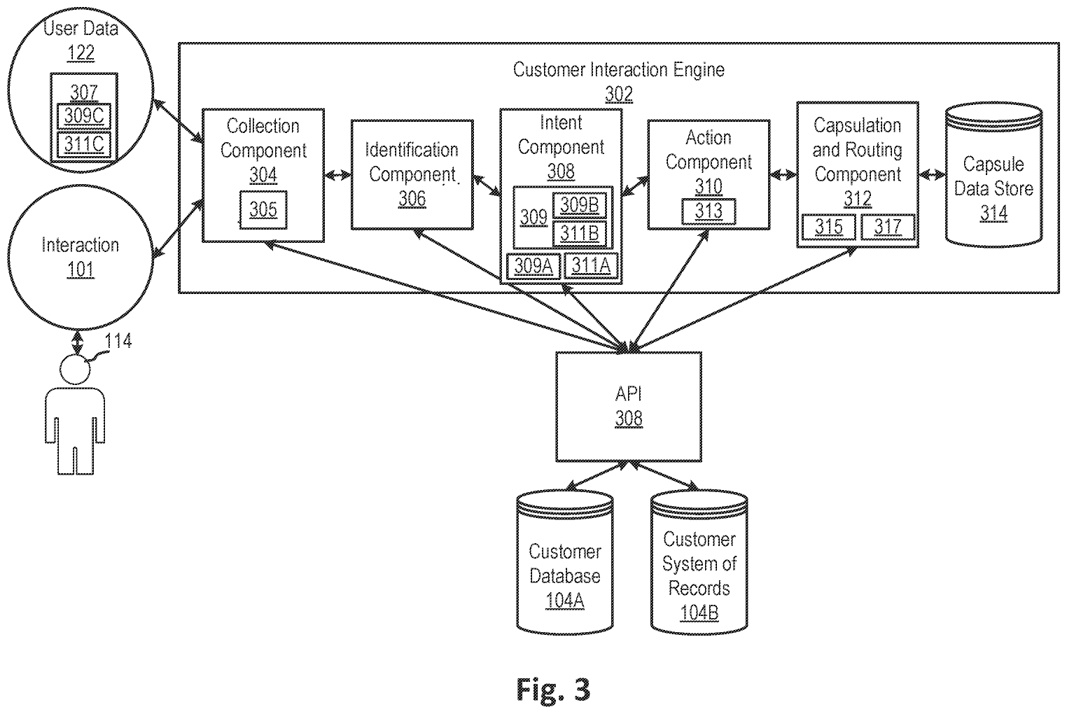

FIG. 3 illustrates an overview of a customer interaction engine 302, in accordance with at least some embodiments of the present disclosure. This diagram is merely an example, which should not unduly limit the scope of the claims. One of ordinary skill in the art would recognize many variations, alternatives, and modifications are possible in light of the present disclosure.

According to certain embodiments, the customer interaction engine 302 receives user data 122 and the interaction 101 via a collection component 304. The collection component 304 can be associated with a human agent 106 or a virtual agent 108 that initially receives the interaction 101. In some examples, the collection component 304 can create a record 305 of the interaction 101. In aspects, some or all of the following information can be included in the record 305: type of channel for the interaction 101, who the user 114 is presently connected to (e.g., a human agent 106 or a virtual agent 108), any correspondence thread associated with the interaction 101, user 114 information included in the interaction 101 (e.g., id, email address, name, etc.), and a status of the interaction 101. Exemplary statuses included, but are not limited to, polled, analyzed, virtual agent 108 engaged, routed, queued, offered to agent, human agent 106 engaged, responded by agent 106, 108, wrap-up, end, etc. In instances, the record 305 can be stored in a customer system of records for the company 116, such as the customer system of records 104B, illustrated in FIG. 2.

Examples records include, but are not limited to, the following examples:

```
  {
    “alternateCustomer”: [
      “0033i00xyz4H3h0AAC”
    ],
    “name”: “John Doe”,
    “id”: “JohnDoe\hat{ }0033i00xyz4H3h0AAC”,
    “contacts”: [
      {
        “filter”: “VOICE”,
        “name”: “John Doe”,
        “id”: “9191234567”,
        “type”: “primary”
      },
      {
        “filter”: “VOICE”,
        “name”: “John Doe”,
        “id”: “+19191234567”,
        “type”: “home”
      },
      {
        “filter”: “VOICE”,
        “name”: “John Doe”,
        “id”: “9193241234”,
        “type”: “primary”
      },
      {
        “filter”: “EMAIL”,
        “name”: “John Smith”,
        “customerId”: “JohnDoe\hat{ }0033i00xyz4H3h0AAC”,
        “id”: “aDoe@xyz.com”,
        “type”: “primary”
      },
      {
        “filter”: “TWILIOSMS”,
        “name”: “John Doe”,
        “id”: “19191234567”,
        “type”: “primary”
      },
      {
        “filter”: “WEBCHAT”,
        “name”: “John Doe”,
        “id”: “John”,
        “type”: “primary”
      },
      {
        “filter”: “S4B”,
        “name”: “John Doe”,
        “id”: “John@xyz.com”,
        “type”: “primary”
      },
      {
        “filter”: “GHOUT”,
        “avatarUrl”: “https://xyz.googleusercontent.com/-
lEkbxyz/AAAAAAAAAAI/AAAAAAAAAAA/xyz/photo.jpg”,
        “name”: “ John Doe ”,
        “customerId”: “ adoe@xyz.com ”,
        “id”: “114806850330483531286xyz”,
        “email”: “ adoe@xyz.com ”
      },
      {
        “filter”: “FBBOT”,
        “profile_pic”: “https://platform-
lookaside.fbsbx.com/platform/profilepic/?psid=1234&width=1024&ext=1561234&hash=xyz”,
        “name”: “John Doe”,
        “last_name”: “Doe”,
        “id”: “2647709251123781”,
        “first_name”: “John”
      }
    ]
    }
```

An example of an email record includes the following:

```
{
  “filter”: “EMAIL”,
  “mode”: “AI”,
  “agent”: [
    {
      “filter”: “ASBOT”,
      “threadId”: “T_e0kxoOyrJjOX”,
      “agent”: “5009”,
      “state”: “unknown”
    },
    {
      “filter”: “ASBOT”,
      “threadId”: “T_jzoM259EM04v”,
      “agent”: “5009”,
      “state”: “unknown”
    },
    {
      “filter”: “ASBOT”,
      “threadId”: “T_BPawPLzQDw2m”,
      “agent”: “5009”,
      “state”: “unknown”
    } ],
  “customerInfo”: {
    “name”: “Jane Doe”,
    “id”: janedoe@convergeone.comI
  },
  “id”: “janedoe@convergeone.com”,
  “state”: “agent”,
  “customer”: {
    “filter”: “EMAIL”,
    “full_name”: “Jane Doe”,
    “name”: “Jane Doe”,
    “id”: “janedoe@convergeone.com”
  },
  “via”: “”,
  “timestamp”: 1588769133775
  }
```

An example of a chat conversation includes the following:

```
{
  “filter”: “”,
  “mode”: “AI”,
  “agent”: [
    {
      “filter”: “ASBOT”,
      “threadId”: “CHAT”,
      “agent”: “5650052”,
      “name”: “”,
      “state”: “unknown”
    }
  ],
  “customerInfo”: {
    “name”: “Jane Doe”,
    “id”: “113953858365719293620”
  },
  “id”: “113953858365719293620-is0CBgAAAAE”
  “state”: “aiEngaged”,
  “customer”: {
    “filter”: “GHOUT”,
    “full_name”: “Jane Doe”,
    “name”: “Jane Doe”,
    “id”: “113953858365719293620”
  },
  “via”: “”,
  “timestamp”: 1588238047229 }
```

After receiving the user data 122 and the interaction 101, the collection component 304 can pass the user data 122, the interaction 101, and the record 305 to an identification component 306.

The identification component 306 can be configured to determine the identity of the user 114 initiating the interaction 101. To do so, the identification component 306 can extract information associated with the interaction 101 including, for example, a name, an id, an email address, other identifying information, metadata, and/or the like included in and/or associated with the interaction 101. In certain embodiments, the identification component 306 can access a customer database 104A and/or a customer system of records 104B via one or more APIs 308 in order to correlate the information in the interaction 101 to a customer included in the customer database 104A and/or a customer system of records 104B in the event the user 114 initiating the interaction 101 is a customer in the company's 116 records. Additionally, or alternatively, the identification component 306 can correlate the information of the interaction 101 to the user data 122. For example, the identification component 306 can correlate information of the interaction 101 to any previous interactions 307 included in the user data 122. As such, the identification component 306 can determine whether the user 114 initiating the interaction 101 has been engaged in any previous interactions 307.

In certain instances, additional information about the user 114 that is not included in the interaction 101 but is included in a customer database 104A, a customer system of records 104B, and/or a previous interaction 307 can be saved to and/or associated with the record 305. In some examples, the information about the user 114 can conform to a user template. An example of a user template is the following:

User Template:

12324345, Steve, CRMID
FB, Stev1, FB profile info,
SMS, 123213
webchat, Steve, location
Skype, Steve.work.c1
Google Hangout Chat, Steve@xyz.com

Furthermore, a link to any previous interactions 307 associated with the user 114 can be formed between the record 305 and any previous interactions 307.

According to certain embodiments, the identification component 306 can pass the identity of the user 114 initiating the interaction 101 to the intent component 308. For example, the identification component 306 can pass to the intent component 308: (i) the user template for the user 114, (ii) any correlation of the user 114 to a customer included in the customer database 104A, and/or (iii) any correlation of the user 114 to a customer included in the customer system of records 104B. As another example, the identification component 306 can pass any correlation of the user 114 to any previous interactions 307 to the intent component 308.

After receiving any identifications from the identification component 306, the intent component 308 can determine an intent 309A associated with the interaction 101. In some aspects, the intent 309A can be associated with the user 114, the agent 106, 108, and/or pertain to a recommended action to be taken in response to the intent 309, as explained in more detail below.

To determine an intent, in certain aspects, the intent component 308 can apply a filter to filter any noise from the interaction 101. Examples of noise in the interaction 101 may include, but are not limited to, small talk, mundane queries, irrelevant queries, etc. In certain embodiments, the filter can identify certain words/phrases included in the interaction 101 that are associated with noise and filter out those words/phrases. Additionally, or alternatively, a machine learning algorithm that is trained on a labelled data set identifying noise in a conversation can be applied to the interaction 101 in order to filter the noise from the interaction 101. In certain embodiments, the intent component 308 can identify the intent 309A before or after a filter is applied to the interaction 101. In even other embodiments, a filter may not be applied to the interaction 101 in order for the intent component 308 to identify an intent 309A in the interaction 101.

In certain embodiments, to determine an intent of the interaction 101, the intent component 308 can compare the content of the interaction 101 and any information associated to the interaction 101 to a list of intents 309. The content of the interaction 101 and any other information associated with the interaction 101 (e.g., user id, username, notes relates to the interaction 101, any association between the interaction 101 and any previous interactions 307, metadata, etc.) can be referred to herein as context data 311A of the interaction 101. Additionally, each intent in the list of intents 309 may include associated context data 311A. And, the intent component 308 can compare the context data 311A of the interaction 101 with context data 311B associated with each intent of the list of intents 309. In the event the context data 311A of the interaction 101 is the same or similar to context data 311B associated with an intent 309B of the list of intents 309, the intent component 308 can identify the intent 309A of the interaction 101 as the intent 309B of the list of intents 309. In some examples, the intent component 308 can assign a percentage likelihood that the intent 309A of the interaction 101 is the intent 309B.

Additionally, or alternatively, the intent component 308 can access previous interactions 307 for the user 114 and determine whether one of the previous interactions 307 have the same or similar context data 311C to the context data 311A of the interaction 101. In the event a previous interaction 307 has the same or similar context data 311C to the context data 311A of the interaction 101, the intent component 308 can identify the intent 309C of the previous interaction 307 as the intent 309A of the interaction 101. In certain embodiments, a previous interaction 307 can be labelled as having an open or a closed state. In some examples, in the event the previous interaction 307 has an open state, the intent 309C of the previous interaction 307 can be used by the intent component 308 to identify the intent 309A of the interaction 101. However, in certain examples, in the event the previous interaction 307 has a closed state, the intent 309C of the previous interaction 307 will not be used by the intent component 308 to identify the intent 309A of the interaction 101. However, it is also contemplated that the prior intents that have a closed states could be reconsidered in the event that there are no intents with open states or none are applicable.

In some examples, the intent of the interaction 101 can be correlated to more than one intent included in the list of intents 309. In these examples, the intent component 308 may assign a percentage likelihood to each intent of the more than one intents to which the intent 309A of the interaction 101 is similar. As such, an agent, for example, a human agent 106 can review the more than one intents, any associated context data 311B to make the determination, and the percentage likelihoods in order to determine an intent of the interaction 101.

In the event the intent component 308 cannot match the intent 309A of the interaction 101 to an intent included in the list of intents 309, the intent component 308 may list the intent 309A of the interaction 101 as a new intent 309A. In embodiments, the intent component 308 can save the new intent 309A and the context data 311A related to the new intent 309A to the list of intents 309. According to certain embodiments, the intent 309A of the interaction 101 can be saved to and/or associated with the record 305.

In certain examples, the list of intents 309 can be determined by a machine learning algorithm that is trained on a labelled data set that identifies different intents and associated context data 311A with each intent of the different intents. Additionally, or alternatively, the list of intents 309 may be determined by one or more humans, for example a human agent 106.

According to certain examples, the intent 309A of the interaction 101 can be either resolved or outstanding. In the event the intent 309A of the interaction 101 is resolved by, for example, an action as discussed below, the intent 309A of the interaction 101 be labelled as closed. Alternatively, if the intent 309A of the interaction 101 is not resolved, the intent 309A of the interaction 101 be labelled as open.

In some examples, the intent of the interaction 101 can conform to an intent template. An example of an intent template is the following:

Intent Template:

CustomerIntents
IntentsName
Status—Open or close
AIName
Friendly Name
CustomerID
ConversationID
Last Update TimeStamp
Last actor—Contact (ID, Name)
last Intent Comments
Last Context [Entity Data]
Events [ ]
   TimeStamp
   Channel
   Action
   Comments
   Actor—Contact {ID, name}
   context[Entity Data]
Actions [ ]
   SendEmail—Template
   SendSMS—message
   Custom-ActionTemplate

Another example of an intent template includes the following:

```
{
    “filter”: “GHangout”,
    “aiName”: “existingTicket”,
    “lastUpdate”: “2020-04-29T20:25:09.618Z”,
    “customerId”: “sivapal@xyz.com”,
    “id”: “existingTicket_sivapal@xyz.com”,
    “state”: “Open”,
    “friendlyName”: “existingTicket”,
    “relevance”: “2020-04-29T20:25:09.559Z”
  }
```

Other examples of intents are included in the following table:

| Intent | | | |
|---|---|---|---|
| Types | Created by | Trigger | Use Case |
| Customer | Customer | Customer using one of the | Customer on a webchat can request |
| | | channels | about “mortgage rates”, which get |
| | | | recorded as intent. |
| | Contact Center | Agent who handles a | Customer chat escalated to Agent. On |
| | Agent | customer on any channel - | the OmniAgent UI, the agent can |
| | | Voice, Email, Chat, | create predefined/new intents to track. |
| | | Messaging can create on | |
| | | behalf of the customer | |
| | CRM via Bots | Agent uses a CRM to | Any lead creation can create an intent |
| | | create/update Customer | against the Customer and when the |
| | | data | next time Customer comes through one |
| | | | of the channels, relevant intent can be |
| | | | used as starting talk point. |
| | Enterprise | Customer using company | Mobile app can create a customer |
| | Website/Mobile | website or mobile app. | intent, saying a specific customer |
| | App | | request some additional info, which |
| | | | can be used to track latest customer |
| | | | interest on other channels also. |
| Agent | Enterprise | AI/NLP engine tracking | For a cancellation of a services, the |
| | AI/Bot Admin | Predefined Intents | enterprise can always pre-define, that a |
| | | | human agent has to be involved and |
| | | | mark these intents to escalation to a |
| | | | “retention” department. |
| Fulfillment | Enterprise | AI/NLP engine tracking | Bot can identify a proactive info |
| | AI/Bot | Predefined Intents | sharing for promotion purposes, based |
| | | | on customer intent identification. |
| | CRM via Bots | Agent uses a CRM to | Customer account is set to have |
| | | create/update Customer | overdraft, which includes some fees |
| | | data | that needs to be notified to the |
| | | | customer. |
| | Enterprise | Customer using company | Mobile app can create a fulfillment |
| | Website/Mobile | website or mobile app. | intent, saying a specific customer |
| | App | | request some additional info, which |
| | | | can be used to create scheduled task to |
| | | | send a SMS with the info requested. |

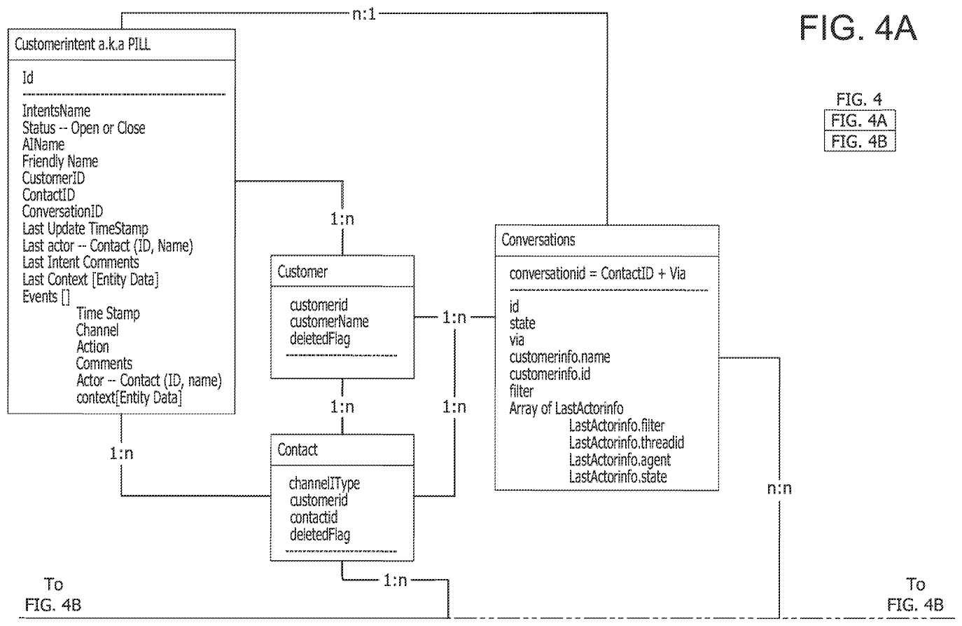

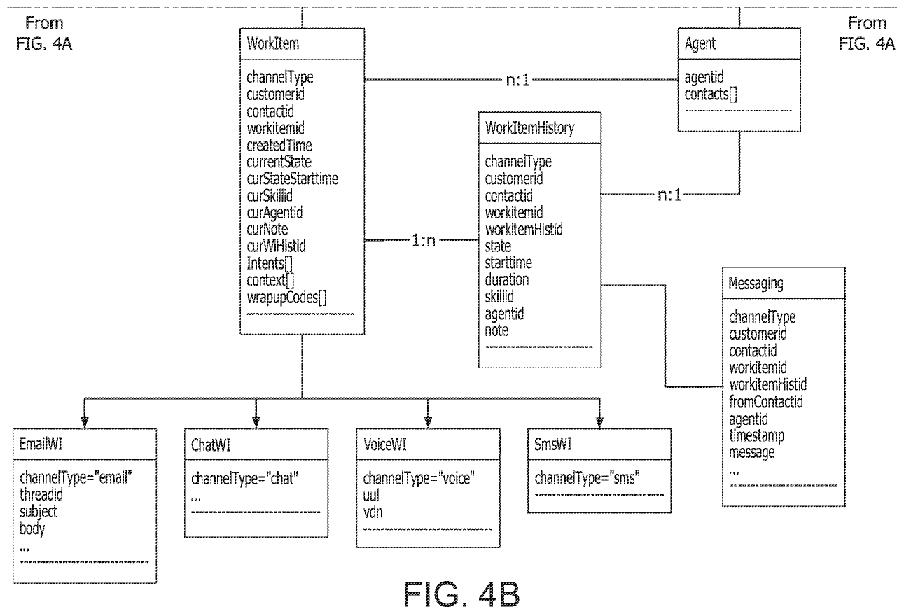

According to some embodiments, the intent 309A of the interaction 101 can be saved to and/or associated with the record 305. Additionally, or alternatively, the intent 309A of the interaction 101 can be associated with other data relating to: (i) the intent 309A, (ii) the interaction 101, (iii) the user 114 initiating the interaction 101, (iv) other metadata, and/or other information. An example relationship between the intent and other information is illustrated in FIGS. 4A and 4B. FIGS. 4A and 4B are merely an example, which should not unduly limit the scope of the claims. One of ordinary skill in the art would recognize many variations, alternatives, and modifications are possible in light of the present disclosure.

Referring back to FIG. 3, the intent component 308 can pass the intent 309A and the context data 311A to an action component 310. The action component 310 can determine using machine learning any recommended actions 313 to be taken in response to the determined intent 309A of the interaction 101. In some instances, the action component 310 determines any recommended actions 313 to be taken based on the context data 311A associated with the interaction 101. Additionally, or alternatively, the action component 310 determines any recommended actions 313 for the interaction 101 by using the same action associated with the intent 309B included in the list of intents 309. Additionally, or alternatively, the action component 310 can use a natural language processor in order to review the context data 311A (e.g., the content of the interaction 101) and determine any recommended actions 313 based on the context data 311A.

According to certain embodiments, the action component 310 can pass the intent 309A, the context data 311A, and any recommended actions 313 to the capsulation and routing component 312. In at least some embodiments, the capsulation and routing component 312 capsulizes the intent 309A, context data 311A, and any recommended actions 313 into an interaction capsule 315, which can be stored in a capsule data store 314. In certain embodiments, the interaction capsule 315 can routed to and be used by a human agent 106 and/or a virtual agent 108 to confirm an intent 309A of an interaction 101 and fulfill any recommended actions 313 for the interaction 101.

In at least some embodiments, the routing component 312 determines whether a human agent 106 or a virtual agent 108 is best suited to fulfill any recommended actions 313. Once the routing component 312 has made this determination, the routing component 312 can route the interaction 101 along with any recommended actions 313 to the appropriate agent 106, 108.

To determine whether a human agent 106 or a virtual agent 108 is best suited to fulfill any recommended actions 313, the routing component 312 can access a lookup table 317 that correlates recommended actions 313 to either a human agent 106 or a virtual agent 108. In instances where the recommended action 313 is correlated to a human agent 106, the routing component 312 can determine a human agent 106 is best suited to fulfill the recommended action 313. And, in instances where the recommended action 313 is correlated to a virtual agent 108, the routing component 312 can determine a virtual agent 108 is best suited to fulfill the recommended action 313. In some examples, each recommended action 313 will have metadata information on how to execute the recommended action 313 and will route the recommended action 313 to either a human agent 106 or a virtual agent 108 based on whether the human agent 106 or virtual agent 108 is better suited to complete the recommended action 313. For example, if the recommended action 313 is ‘Send SMS’, then the metadata of the recommended action 313 will have the following data: Action ID, Conversation ID, EndPoint ID, Customer ID, Customer Name, From, To, Message, Channel To Use, Create Datetime, Scheduled Datetime. In the event this metadata included in the recommended action 313 is enough for a virtual agent 108 to complete the recommended action 313, then the routing component 312 will route the recommended action 313 to a virtual agent 108. Conversely, if the metadata included in the recommended action 313 is not enough for a virtual agent 108 to complete the recommended action 313, then the routing component 312 will route the recommended action 313 to a human agent 106.

According to certain embodiments, the interaction capsule 315 enables companies to deliver on the expectations of a digitally diverse customer base. The customer interaction engine 312 and the interaction capsule 315 can be the central point for all communication that integrates all needed elements to achieve customer empowerment. By thinking about customer interaction engine 302 as the central hub, other elements like contact center infrastructure, customer relationship management, artificial intelligence, bots, internet of things, video collaboration, etc. all become endpoints that achieve their goals while the customer interaction engine records every transaction and stores/manages relevant context based on outcomes. The interaction capsule 315 encapsulates this transaction, customer, business and pertinent associated data, thereby enabling data science methods including machine learning to achieve actionable business insights previously unattainable.

Further, the interaction capsule 315 is comprised of software designed to provide actionable insights at all levels of the enterprise. For example, the interaction capsule 315 contains pertinent operational, transactional, personal, sentiment, and financial data relative to a specific customer and their interactions with the enterprise. The range of use cases for interaction capsule 315 includes providing valuable actionable data to channels (human or electronic) so those channels can efficiently produce customer outcomes using the actionable data, all the way to sophisticated multi-experience analytics driven by machine learning.

Being able to determine the intent of an interaction using the interaction capsule 315 ensures relevant and current customer context (who are you, why and how are you contacting us, and what is the relevant conversation history and best action) is provided to every channel, digital or human, during the customer journey with an enterprise. Encapsulating the proliferation of interaction channels and associated data into an interaction capsule 315 is critical for businesses wanting to differentiate their brands through superior customer experiences.

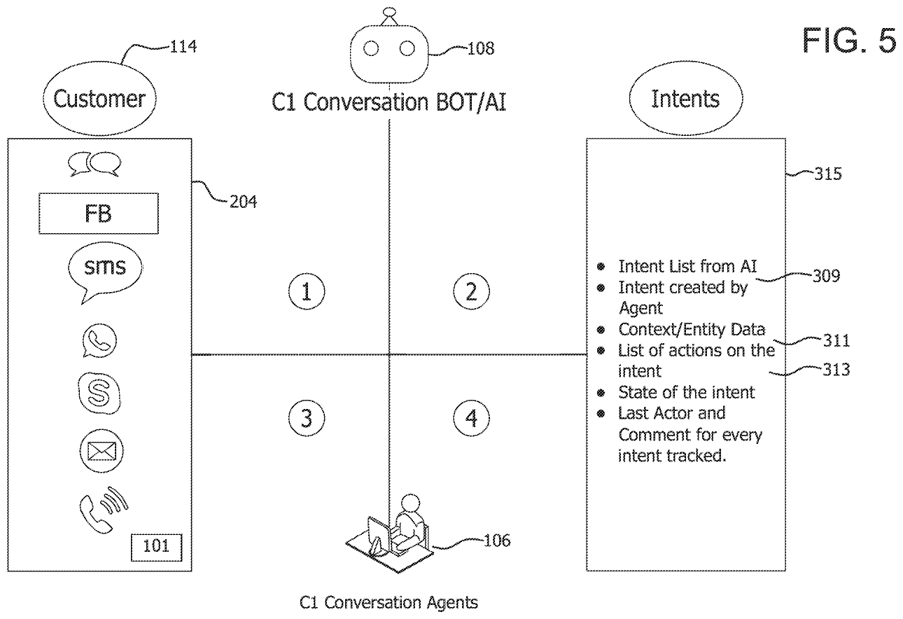

FIG. 5 is a diagram of an example of customer identification and intent tracking. This diagram is merely an example, which should not unduly limit the scope of the claims. One of ordinary skill in the art would recognize many variations, alternatives, and modifications are possible in light of the present disclosure.

As illustrated, an interaction 101 is initiated by a user (e.g., a customer) 114 via one or more channels 204. As set forth above, exemplary channels include, but are not limited to, voice, email, webchat, SMS, Facebook Messenger, Twitter, Skype, MS teams, Cisco Teams, Slack, LINE, WhatsApp, etc. After the initiation of the interaction 101, the interaction can be routed to a human agent 106 or a virtual agent 108 by, for example, the collection component 304 (of FIG. 3). In certain instances, the customer interaction engine 302 (of FIG. 3) reviews and analyzes the interaction 101 to create a record 305 of the interaction 101, identify the user 114, determine any intents 309 and the state of any intents, determine any context data 311 (e.g., the last actor and comment for every intent tracked), determine any recommended actions 313, and encapsulate this information in a capsule 315 for review by the human agent 106 and/or the virtual agent 108. In aspects, the customer interaction engine 302 can perform these steps, (i) prior to routing the interaction 101 to a human agent 106 or a virtual agent 108 or (ii) after routing the interaction 101 to a human agent 106 or a virtual agent 108.

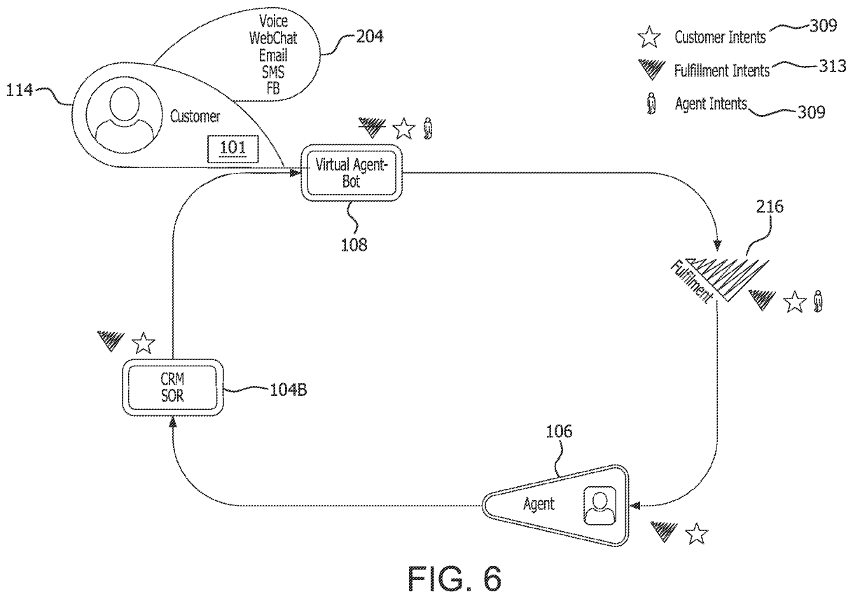

FIG. 6 is a diagram of an example of an interaction cycle fulfillment. This diagram is merely an example, which should not unduly limit the scope of the claims. One of ordinary skill in the art would recognize many variations, alternatives, and modifications are possible in light of the present disclosure.

Similar to FIG. 5, FIG. 6 may begin with the initiation of an interaction 101 by a user (e.g., a customer) 114 via one or more channels 204. After the initiation of the interaction 101, the interaction 101 may be received by a virtual agent 108. The customer interaction action 302 can determined any intents 309 (including any customer intents and/or agent intents) and actions 313 for the interaction 101. In the event the virtual agent 108 is able fulfill any actions 113 for the intents 309, the interaction 101 can progress to a fulfillment module 216 where the actions 113 can be fulfilled. In certain embodiments, one or more of the actions 113 may need to be fulfilled by a human agent 106. In these instances, the interaction 101 can progress to the human agent 106, as shown. Then, the human agent 106 can fulfill any remaining actions 113 of the interaction 101. To do so, in certain embodiments, a customer system of records 104B may be accessed. Additionally, or alternatively, the interaction 101, the intents 309, actions 313, etc. can be saved to the customer system of records 104B.

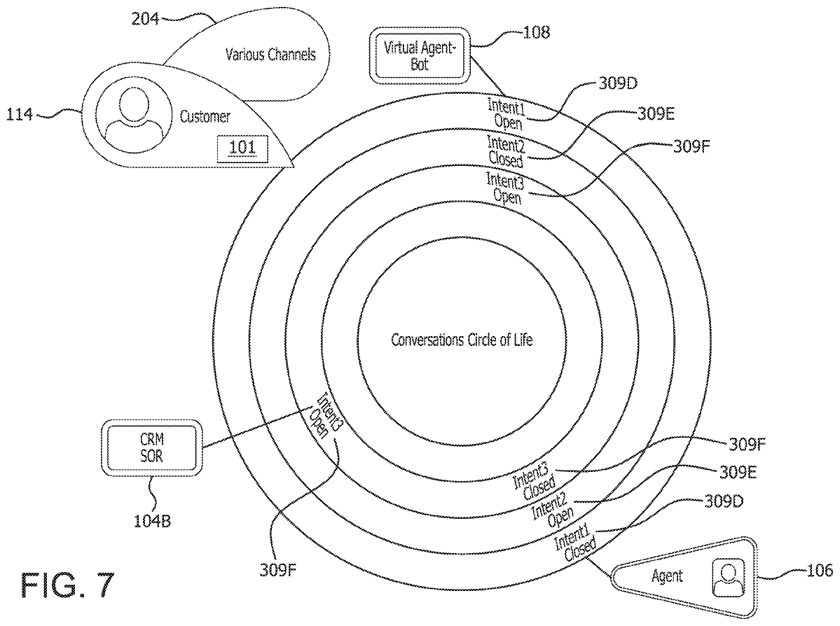

FIG. 7 is a diagram of an example of an intent lifecycle. This diagram is merely an example, which should not unduly limit the scope of the claims. One of ordinary skill in the art would recognize many variations, alternatives, and modifications are possible in light of the present disclosure.

Similar to FIGS. 5 and 6, FIG. 7 may begin with the initiation of an interaction 101 by a user (e.g., a customer) 114 via one or more channels 204. After the initiation of the interaction 101, the interaction 101 may be received by a virtual agent 108. The customer interaction action 302 can determined any intents 309D, 309E, 309F (including any customer intents and/or agent intents) and any actions for the intents 309D, 309E, 309F. In the illustrated embodiment, the virtual agent 108 is able to fulfill or attempt to fulfill any actions associated with intents 309D, 309F. As such, intents 309D, 309F are illustrated as being open for the virtual agent 108 to fulfill. As shown, however, the intent 309F also requires a customer system of records 104B to fulfill. As such, the intent 309F is passed to the customer system of records 104B.

Further, as illustrated, intent 309E may require some action by a human agent 106 to fulfill. As such, the intent 309E is shown as being closed for the virtual agent 108. However, when the interaction 101 and intents 309D, 309E, 309F pass to the human agent 101, the intents that the human agent 106 will fulfill or attempt to fulfill are shown as being open. As such, intent 309E is shown as being open and intents 309D, 309F, which are fulfilled by the virtual agent 108 and/or the customer system of records 104B, are shown as being closed. If the human agent 106 is able to fulfill the intent 309E, then the intent 309E can be changed to closed after the intent 309E is fulfilled. In certain embodiments, any intents 309D, 309E, 309F that are not fulfilled by the human agent 106, such as intents 309D, 309F, may not be passed to the human agent 106.

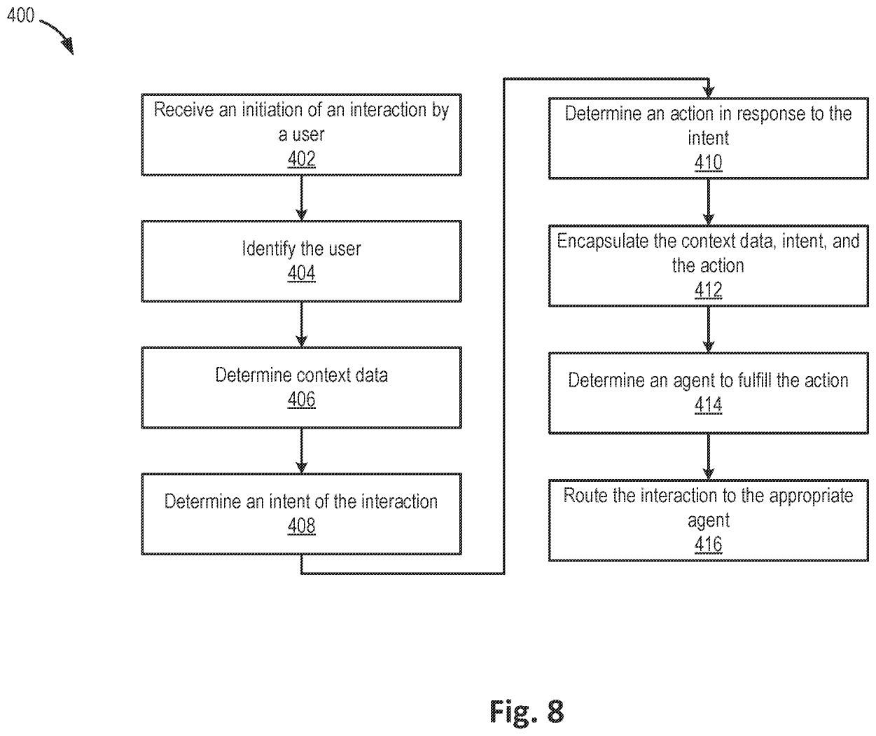

FIG. 8 is a flow diagram of a method 400 for managing and analyzing customer interactions. This diagram is merely an example, which should not unduly limit the scope of the claims. One of ordinary skill in the art would recognize many variations, alternatives, and modifications are possible in light of the present disclosure.

As illustrated, the method 400 includes receiving an initiation of an interaction by a user (block 402). In instances, the initiation of the interaction can be the same or similar as any of the in interactions described above. For example, the interaction may be initiated via a variety of channels including, but not limited to, voice, email, webchat, SMS, Facebook Messenger, Twitter, Skype, MS teams, Cisco Teams, Slack, LINE, WhatsApp, or YouTube.

Further, the method 400 includes identifying the user (block 404) and determining any context data (block 406). Identifying the user and determining any context data may be performed using the same or similar methods as described above. For example, the identification component 306 may identify the user using the techniques described above and the intent component 308 can determine any context data using the techniques describe above.

More specifically, for example, to determine any context data, the method 400 associated the user with a previous interaction of the user, based on the identity of the user. Then, the method 400 may determine whether the previous interaction is relevant to the current interaction. And, if the previous interaction is relevant to the current interaction, then the method 400 may include the previous interaction as context data. In some instances, to determine if a previous interaction is relevant to the current interaction, the method 400 may include determining a state of the previous interaction, such as an open state or a closed state. In aspects, only previous interactions that are open may be deemed relevant to the current interaction. As set forth above, the current interaction and the previous interaction may be received via different channels.

According to certain embodiments, the method 408 can include determining an intent of the interaction (block 408). Determining an intent of the interaction may be performed using the same or similar methods as described above. For example, the intent component 308 can determine any intents of the interaction using the techniques described above. More specifically, in some embodiments, the intent component 308 can access a database of a plurality of intents, match context data and/or other data related to the current interaction to context data associated with one or more intents of the plurality of intents. And, based on the match, determine the intent of the current interaction to be the same or similar intent as the intent of the one or more matched intents. Additionally, or alternatively, any relevant previous interactions can be used to help determine the intent of the current interaction.

According to certain embodiments, the method 408 can include determining an action in response to the intent (block 410). Determining an action in response to the intent may be performed using the same or similar methods as described above. For example, the action component 310 can determine any recommended actions to be taken in response to the intent. After which, the method 400 may include encapsulating the context data, any intents, and any actions into a capsule (block 412), which can be provided to an appropriate agent, for example, a human agent 106 and/or a virtual agent 108.

In some instances, the method 400 can include determining an agent best suited to fulfill the action (block 414). Determining an agent best suited to fulfill the action may be performed in the same or similar manner as describe above, such as by the capsulation and routing component (block 312). After determining the best agent suited to fulfill the action, the method 400 may include routing the capsule to the appropriate agent (block 416).

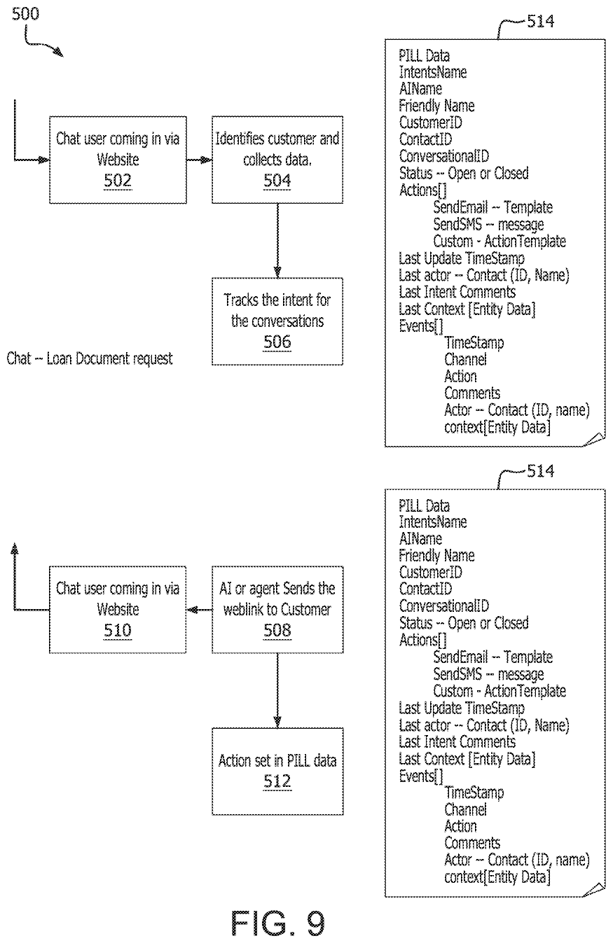

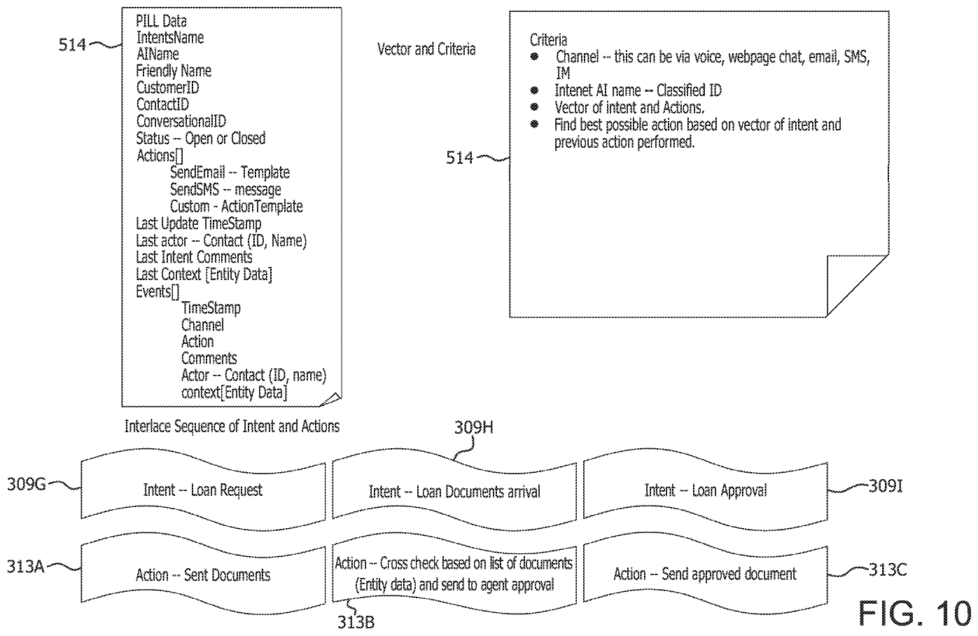

FIGS. 9 and 10 are diagrams of a method 500 for an example customer interaction. This diagram is merely an example, which should not unduly limit the scope of the claims. One of ordinary skill in the art would recognize many variations, alternatives, and modifications are possible in light of the present disclosure.

In the illustrated embodiment, the method 500 is the fulfillment of a loan document request. The loan document request is an example of what has been referred to herein as the initiation of an interaction 101. As shown, the user (e.g., the customer) 114 contacts a contact center through the website via webchat (block 502). The customer interaction engine 304 identifies the user (block 504) and starts tracking the request 101 (block 506). The request 101 is to get help on a loan request application. The user is completing the application on the bank website and has questions. The customer interaction engine 304 identifies the intent (e.g., the intent 309G shown in FIG. 10) as “Loan Request Query” (block 508) and answers via an AI-powered virtual assistant (block 510). The follow-up (e.g., action) to the request is for the user to send/upload a pay statement (action 313A of FIG. 10) and a “for sale” agreement (block 512). This information can be stored in one or more capsules 514.

Referring to FIG. 10, the customer interaction engine 304 tracks the next action (e.g., 313B) as Loan Documents arrival. When the documents arrive, customer interaction engine 304 has templated actions 313B to follow-up and complete the process. The customer interaction engine 304 can leverage human agents 106 to help with this process, such as when the best action for document arrival is to send it to a human agent 106 for approval (i.e., intent 3091) and wait for next action (action 313C), the customer interaction engine 304 follows through as intent changes in the process and next best action changes.

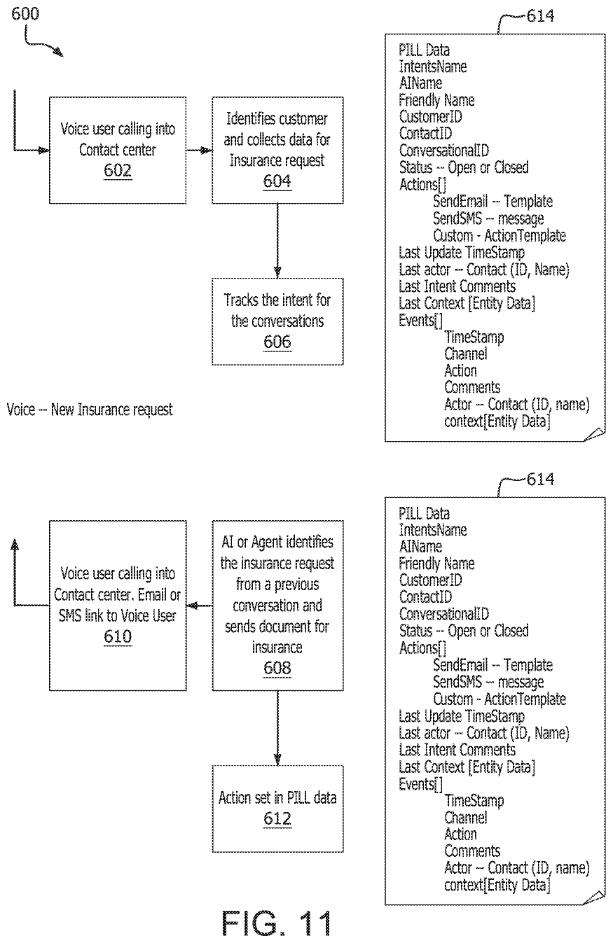

FIG. 11 is a diagram of a method of another example customer interaction. This diagram is merely an example, which should not unduly limit the scope of the claims. One of ordinary skill in the art would recognize many variations, alternatives, and modifications are possible in light of the present disclosure.

In the illustrated embodiment, the method 600 is the fulfillment of a new insurance request. The new insurance request is an example of what has been referred to herein as the initiation of an interaction 101. As shown, a user (e.g., a customer) 114 contacts a contact center through the website via webchat (block 602). The customer interaction engine 304 identifies the user (block 604) and starts tracking the request (block 606). The request is to get help on a new insurance request. The user is completing the application for a new insurance request (e.g., quote) and has questions. The customer interaction engine 304 identifies the intent as “New Insurance Request” (block 608) and answers via an AI-powered virtual assistant (block 610). The follow-up to the request is for the user to send/upload one or more application documents for the insurance request (block 612). For example, the next best action can be collection of documents by sending in the upload info via email or SMS. Based on the user information available, the Virtual Assistant (VA) can ask what is preferable for user and send the next best action communication via that channel. This information can be stored in one or more capsules 614.

According to certain embodiments, the methods 500, 600 and any of the embodiments disclosed herein can be processed across channels because the intents/actions are attached to the user rather than the channels in which they are interacting.

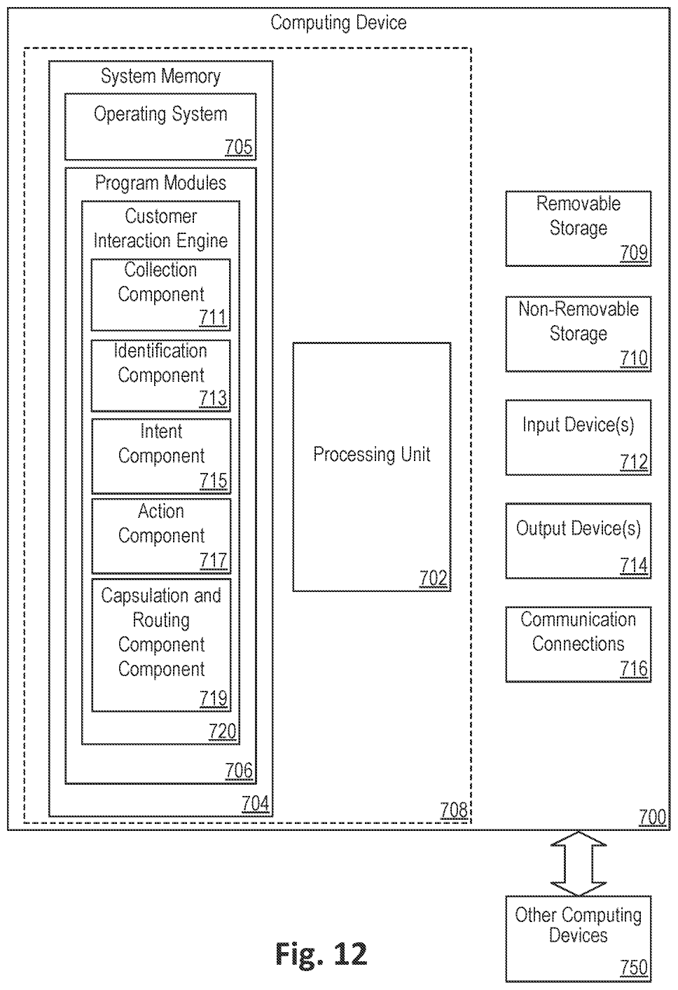

FIG. 12 is a block diagram illustrating physical components (e.g., hardware) of a computing device 700 with which aspects of the disclosure may be practiced. The computing device components described below may have computer executable instructions for implementing a customer interaction engine 720 (e.g., customer interaction engine 302), including computer executable instructions for a customer interaction engine 720 that can be executed to implement the methods disclosed herein (e.g., methods 400,500,600). In abasic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running the customer interaction engine 720, such as one or more components with regard to FIG. 3 and, in particular, a collection component 711 (e.g., collection component 304), an identification component 713 (e.g., identification component 306), an intent component 715 (e.g., intent component 308), an action component 717 (e.g., action component 310), and/or a capsulation and routing component 719 (e.g., a capsulation and routing component 312).

The operating system 705, for example, may be suitable for controlling the operation of the computing device 700. Furthermore, embodiments of the disclosure may be practiced in conjunction with a graphics library, other operating systems, or any other application program and is not limited to any particular application or system. This basic configuration is illustrated in FIG. 12 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 12 by a removable storage device 709 and a non-removable storage device 710.

As stated above, a number of program modules and data files may be stored in the system memory 704. While executing on the processing unit 702, the program modules 706 (e.g., corresponding to customer interaction engine 720) may perform processes including, but not limited to, the aspects, as described herein. Other program modules that may be used in accordance with aspects of the present disclosure, and in particular for implementing customer interaction engine 706, may include a collection component 711, an identification component 713, an intent component 715, an action component 717, and/or a capsulation and routing component 719, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 12 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 700 may also have one or more input device(s) 712 such as visual image sensors, audio sensors, a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

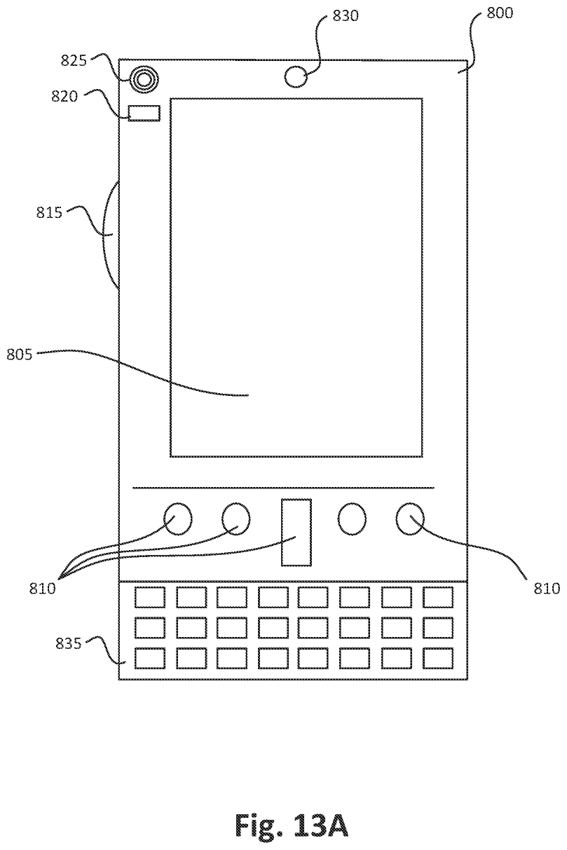

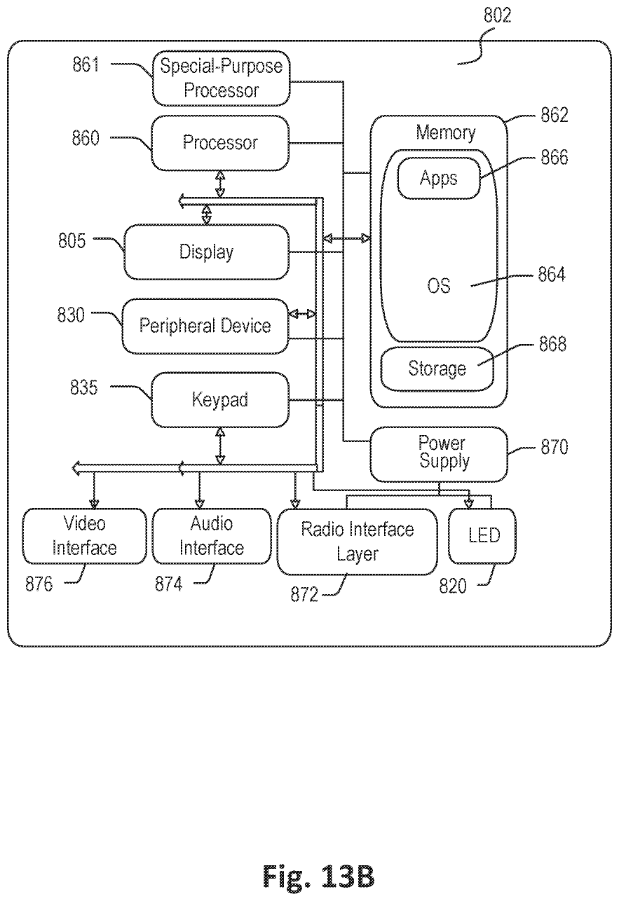

FIGS. 13A and 13B illustrate a mobile computing device 800, for example, a mobile telephone, a smart phone, wearable computer (such as a smart watch), a tablet computer, a laptop computer, and the like, with which embodiments of the disclosure may be practiced and/or accessed (e.g., accessing the capsule 315).

With reference to FIG. 13A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 13B is a block diagram illustrating the architecture of one aspect of a mobile computing device 800. That is, the mobile computing device 800 can incorporate a system (e.g., an architecture) 802 to implement some aspects. In one embodiment, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as email or other messages used by an email application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800, including the instructions for providing a unified matching engine as described herein (e.g., collection component, matching component, and/or identity-graph component, etc.).

The system 802 has a power supply 870, which may be implemented as one or more batteries. The power supply 870 may further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via an audio transducer 825 (e.g, audio transducer 825 illustrated in FIG. 13A). In the illustrated embodiment, the visual indicator 820 is a light emitting diode (LED) and the audio transducer 825 may be a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of peripheral device 830 (e.g., on-board camera) to record still images, video stream, and the like. Audio interface 874, video interface 876, and keyboard 835 may be operated to receive input (e.g., a verbal cue or a textual cue, as described herein).

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 13B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

As should be appreciated, FIGS. 13A and 13B are described for purposes of illustrating the present methods and systems and are not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system for managing customer interactions, the system comprising:
at least one processor; and
memory storing instructions that, when executed by the at least one processor, causes the system to perform a set of operations, the set of operations comprising:
receiving an initiation of an interaction from a user via a first channel, the interaction comprising interaction data;
identifying the user based on the interaction data;
determining context data associated with the user;
determining an intent of the interaction based upon the interaction data and the context data;
encapsulating the interaction, the intent of the interaction, the interaction data, and the context data into an interaction capsule; and
routing the interaction capsule to an agent for completion of an action in response to the intent of the interaction.

2. The system of claim 1, wherein determining context data associated with the user comprises:
associating the user with at least one previous interaction of the user;
determining one or more previous interactions of the at least one previous interaction that are relevant to the interaction; and
including previous interaction data associated with the one or more previous interactions in the context data.

3. The system of claim 2, wherein the at least one previous interaction is associated with a second channel that is different than the first channel.

4. The system of claim 3, wherein the first channel and the second channel are selected from the following group of channels: voice, email, webchat, SMS, Facebook Messenger, Twitter, Skype, MS teams, Cisco Teams, Slack, LINE, WhatsApp, or YouTube.

5. The system of claim 2, wherein determining one or more previous interactions of the at least one previous interaction that are relevant to the interaction comprises:
determining a state of the one or more previous interactions, wherein the state comprises an open state or a closed state; and
determining only a previous interaction of the one or more previous interactions having an open state are relevant to the interaction.

6. The system of claim 5, wherein determining the intent of the interaction comprises using an intent of the previous interaction as the intent of the interaction.

7. The system of claim 1, wherein determining the intent of the interaction comprises:
accessing a database of a plurality of intents, each of the plurality of intents being associated with context data;
matching the interaction data and the context data to the context data associated with one or more intents of the plurality of intents; and
determining the intent of the interaction as the intent of the plurality of intents being associated with the intent data.

8. The system of claim 1, wherein the set of operations further comprises determining an action in response to the intent of the interaction, wherein the action is included in the interaction capsule.

9. The system of claim 8, wherein the set of operations further comprises:
determining the agent to fulfill the action, wherein the agent is a virtual agent or a human agent; and
routing the interaction and an interaction capsule to the agent, the interaction capsule comprising the intent of the interaction and the action.

10. The system of claim 1, wherein the set of operations further comprises:
determining the interaction is associated with the at least one previous interaction; and
updating an interaction capsule based on the interaction.

11. A method for managing customer interactions, the method comprising:
receiving an initiation of an interaction from a user via a first channel, the interaction comprising interaction data;
identifying the user based on the interaction data;
determining context data associated with the user; and
determining an intent of the interaction based upon the interaction data and the context data.

12. The method of claim 11, wherein determining context data associated with the user comprises:
associating the user with at least one previous interaction of the user;
determining one or more previous interactions of the at least one previous interaction that are relevant to the interaction; and
including previous interaction data associated with the one or more previous interactions in the context data.

13. The method of claim 12, wherein the at least one previous interaction is associated with a second channel that is different than the first channel.

14. The method of claim 13, wherein the first channel and the second channel are selected from the following group of channels: voice, email, webchat, SMS, Facebook Messenger, Twitter, Skype, MS teams, Cisco Teams, Slack, LINE, WhatsApp, or YouTube.

15. The method of claim 12, wherein determining one or more previous interactions of the at least one previous interaction that are relevant to the interaction comprises:
determining a state of the one or more previous interactions, wherein the state comprises an open state or a closed state; and
determining only a previous interaction of the one or more previous interactions having an open state are relevant to the interaction.

16. The method of claim 15, wherein determining the intent of the interaction comprises using an intent of the previous interaction as the intent of the interaction.

17. The method of claim 11, wherein determining the intent of the interaction comprises:
accessing a database of a plurality of intents, each of the plurality of intents being associated with context data;
matching the interaction data and the context data to the context data associated with one or more intents of the plurality of intents; and
determining the intent of the interaction as the intent of the plurality of intents being associated with the intent data.

18. The method of claim 11, further comprising determining an action in response to the intent of the interaction.

19. The method of claim 18, further comprising:
determining an agent to fulfill the action, wherein the agent is a virtual agent or a human agent; and
routing the interaction and an interaction capsule to the agent, the interaction capsule comprising the intent of the interaction and the action.

20. The method of claim 11, further comprising:
determining the interaction is associated with the at least one previous interaction; and
updating an interaction capsule based on the interaction.
